(19) United States
(12) Patent Application Publication
(10) Pub. No.: US 2003/0107227 A1
(43) Pub. Date: Jun. 12, 2003

(54) Article Gripping Device for Automation Technology

(75) Inventor: Peter Nagler, Fellbach (DE)

(73) Assignee: imt robot AG, Fellbach, 70736 (DE)

(21) Appl. No.: 10/065,984

(22) Filed: Dec. 6, 2002

(30) Foreign Application Priority Data
Dec. 6, 2001 (DE) 10159921.8

(51) Int. Cl. B25J 15/06

(52) U.S. Cl. 294/64.1

(57) ABSTRACT

### Abstract of Disclosure

An article gripping device for automation technology has a base member having a flat side. Gripping elements having a gripping head are arranged on the flat side of the base member. The gripping head has a contact surface resting against the article being gripped, wherein the gripping head has an active gripping position in which an article is gripped and an initial position in which no article is gripped. The contact surface in the active gripping position is retracted relative to a first position of the contact surface in the initial position of the gripping head. In the active gripping position, the gripping element is sunk into the flat side of the base member and the contact surface of the gripping head is positioned approximately in the plane of the flat side. The flat side of the base member forms a support surface for the article.

### Background of Invention

1. Field of the Invention.

The invention relates to an article gripping device to be employed in the automation technology, in particular, in connection with a robot arm. The gripping device comprises a base member and at least one gripping element arranged on a flat side of the base member and having a gripping head whose contact surface resting against the article when gripping it is retracted in an active gripping position relative to an initial position in which it is detached from the article.

2. Description of the Related Art.

In the automation technology articles to be handled by a gripping device are gripped and moved along a movement or transport path to a desired target location. For example, in the food industry gripping devices for articles are known which are comprised of two gripping elements which are secured on a common baseplate. The gripping elements, for example, are suction devices which, when a pneumatic under pressure (vacuum) is supplied, adhere to the surface of an article to be gripped and grip this article. The article which is fixed in position by the two gripping elements of a gripping device is then lifted and moved along a three-dimensional movement or transport path to the target location. Depending on the transport path, significant acceleration forces can act on the gripped article; they increase the risk of detachment of the article from the gripping device. In the case of articles which are flaccid or slack, such as raw sausages or the like, swinging (pendulous movements) can occur during handling of the articles and this can cause the article to become detached from the suction device so that the article will drop. Therefore, in particular, in the prior art handling of such flaccid or slack articles, certain accelerations may not be surpassed and directional changes of the transport path may not be carried out in rapid sequence. The output capacity of a robot sorting device, for example, is thus limited in this way.

### Summary of Invention

It is an object of the present invention to further develop an article gripping device of the aforementioned kind such that a fixation of the gripped articles is ensured even at high accelerations and rapid directional changes.

In accordance with the present invention, this is achieved in that the gripping element is recessed or sunk into the flat side of the base member and that the contact surface of the gripping head in the active gripping position is positioned approximately in the plane of the flat side, wherein the flat side of the base member forms a support surface for the article that is being gripped.

In the rest (initial) position the gripping heads of the gripping elements of the gripping device are positioned at a spacing in front of the flat side of the gripping device so that a safe contacting of the article to be gripped is ensured. Since the gripping elements are sunk or recessed in the flat side of the base member, the suction cups of the gripping head in the active gripping position can be retracted into the base member so that they are approximately located in the plane of the flat side (are flush with the flat side) in the active gripping position. In this way, the article rests against the flat side of the base member so that the flat side of the base member provides an abutment surface for the gripped article. In this way, a slack (flexible or flaccid) article is aligned by contacting the support surface, i.e., is aligned approximately parallel to the plane of the support surface. This means that a gripped article is not only gripped at two spaced apart locations but is also supported or secured against movement in the area between the two gripping elements. In particular for articles such as raw sausages and the like, it is ensured in this way that the article itself will not undergo pendulous movements or swinging during handling so that even for accelerations and rapidly carried out directional changes a safe securing and holding of the article on the article gripping device is provided. It is also important in this connection that the contact surface has a certain coefficient of friction so that the article is supported by frictional forces in the plane of the contact surface.

Preferably, the gripping head is positioned with minimal radial play in a receiving bore of the base member wherein the inner circumferential surface of the receiving bore forms a lateral support for the suction device of the gripping head. Even in the case of great horizontal accelerations a lateral deflection of the gripping head relative to the base member is prevented and this counteracts a possible detachment of the article from the gripping device.

Advantageously, the base member has a parallelepipedal shape with inner recesses wherein the recesses are open at least toward one lateral surface, in particular, relative to the support surface of the base member. The recesses are greater than the mounting opening for the gripping element provided in the flat side so that as little mass as possible is provided. Preferably, the base member of the article gripping device is made of a plastic material, in particular, POM (polyoxymethylene, polyacetal).

### Brief Description of Drawings

Fig. 1 is a perspective view of the gripping device for articles according to the invention with a schematically indicated article.

Fig. 2 is a perspective illustration showing the gripping device of Fig. 1 in an exploded view.

Fig. 3 is a perspective view of the base member of the gripping device of Fig. 1 from below.

Fig. 4 is a perspective side view of the base member of Fig. 3.

Fig. 5 is a section of the base member or Fig. 4 along the line V-V of Fig. 4.

### Detailed Description

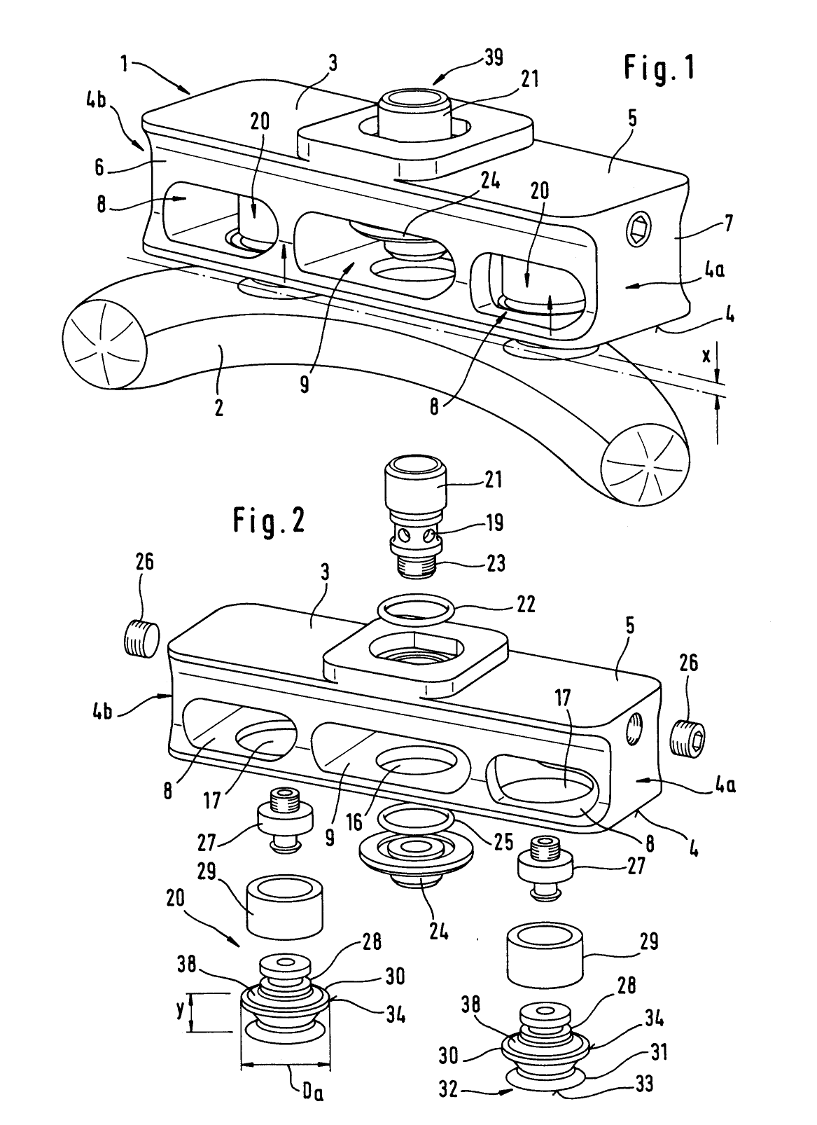

The griping device 1 illustrated in Fig. 1 is used primarily in automation technology, for example, by being connected to a robot arm for gripping articles 2. The articles 2 can be articles of any kind; in the illustrated embodiment they are articles encountered in the food industry. Such flaccid or slack articles can be, for example, sausages and the like.

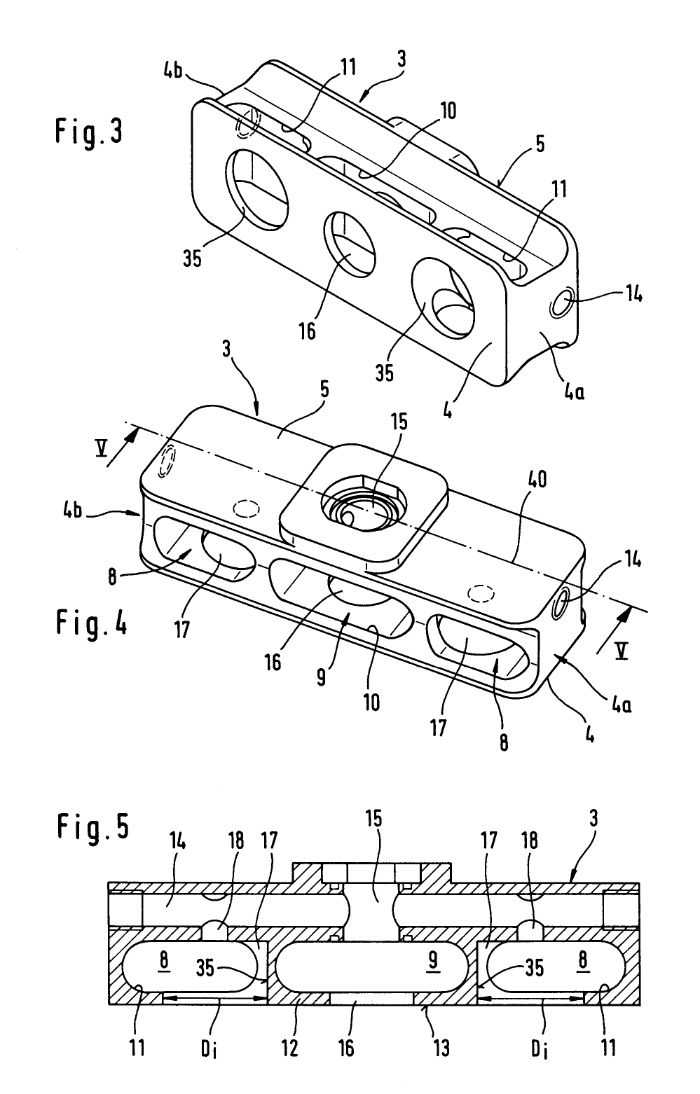

The gripping device 1 is comprised of a base member 3 which, in the illustrated embodiment, has a substantially parallelepipedal shape. The base member 3 has a lower flat or plane side 4, an upper flat or plane side 5, as well as long narrow sides 6 and short narrow sides 7. As shown in the individual illustrations of the base member according to Figs. 3 to 5, the base member has inner recesses 8 and 9 wherein the recess 9 is a central recess which, in the longitudinal direction of the base member 3, is arranged at its center. The central recess 9 is moreover open toward the long narrow sides 6. The recess 9 across the entire width of the base member 3 has an identical cross-section which corresponds to the cross-section of the narrow openings 10.

At the ends of the base member 3 and adjacent to the central recess 9, end recesses 8 are provided which, as illustrated in Fig. 5, are also open toward the long narrow sides 6. The openings 11 in the long narrow sides 6 have a shape of a rectangle that is rounded ovally. The cross-section of the openings 11 corresponds to the cross-section of the recess 8, respectively.

The bottoms of the recesses 8 and 9 form a common support plate 12 whose support surfaces 13 corresponds to the flat side 4 of the base member 3. In the base member 3, an operating medium channel 14 extending in the longitudinal direction of the base member 3 is arranged above the recesses 8 and 9 and crosses a central bore 15 at a right angle. The central bore 15 begins at the upper flat side 5 of the base member 3 and opens into the central recess 9. Opposite the central bore 15, a central mounting opening 16 is provided in the bottom of the recess 9. Its diameter is greater than the diameter of the central bore 15.

Beginning at the lower flat side 4, which forms the support surface 13, receiving bores 17 for the gripping elements 20 are provided in the base member 3. The receiving bores 17 are positioned off-center relative to the recesses 8 as well as laterally displaced relative to the central recess 9. They end in a connecting bore 18 which opens into the operating medium channel 14.

As illustrated in Fig. 2, an adapter flange 21 is inserted in the central bore 15 and is sealed by a sealing ring 22 relative to the upper flat side 5. The adapter flange 21 has transverse bores 19 which are positioned within the operating medium channel 14 and ensure flow connection between the adapter flange 21 and the operating medium channel 14.

The adapter flange 21 penetrates the central bore 15 with a threaded end 23. For securing the adapter flange 21 of the central bore 15 of the base member 3, a knurled nut 24 is screwed onto the threaded end 23. Between the knurled nut 24 and the roof of the recess 9 an additional sealing ring 25, in the embodiment illustrated in the drawings an O-ring, is arranged for providing a sealing action. The operating medium channel is closed off at the its ends by screwed-in plugs 26 so that operating medium introduced via the adapter flange 21 is distributed into the connecting bores 18.

In each of the connecting bores 18 of a receiving bore 17 in the recess 8, a suction adapter 27 is screwed in and a suction member 28, similar to a bellows and made of elastic material, is plugged onto the suction adapter 27. For stabilizing the suction device 28 it is surrounded at least partially by a support ring 29, wherein the support ring 29 is arranged between the suction device 28 and the suction adapter 27.

The suction device 28 has an outer ring 30 which defines the maximum outer diameter of the suction device 28. Below the outer ring 30 a suction cup 31 is provided which forms the gripping head 32 and defines a contact surface 33.

The inner diameter Dᵢ of the receiving bore 17 is slightly greater than the outer diameter Dₐ of the outer ring 30 of the suction device 28. In the mounted position of the gripping element 20 in the receiving bore 17, the outer circumferential surface 34 of the outer ring 30 is positioned with minimal radial play relative to the inner circumferential surface 35 of the receiving bore 17. In this way, the inner circumferential surface 35 of the receiving bore 17 can laterally support the suction device 28 so that the article 2 gripped by the suction device is safely held even when the gripping device 1 is accelerated.

As shown in Fig. 1, on the flat side 4 of the base member 3 of the gripping device 1 facing the article 2, two gripping elements 20 are arranged which are positioned at a spacing to one another and, in the illustrated embodiment, are positioned at the remotely positioned ends 4a, 4b of the base member 3. The gripping elements 20 are positioned, when viewed in a plan view, preferably symmetrically to the longitudinal center axis 40 of the base member 3 wherein the longitudinal center axis 40 at the same time symmetrically divides the flat side 4 and 5. It is also possible to arrange more than two gripping elements which are positioned on a common straight line or on the corner points of any suitable plane shape (triangle, rectangle, circle).

In an initial position of the article gripping device 1 the suction cups 31 of the gripping heads 32 are positioned, for example, at a spacing x to the flat side 4 of the base member 3. The suction cups 31 of the gripping heads 32 have a smaller maximum diameter than the outer ring 30 or the inner diameter of the receiving bore 17. In this way, the suction cups 31 can be immersed into the receiving bores 17 in the base member 3 so that a gripping element can be positioned in an active gripping position so as to be retracted substantially in a receiving bore 17.

When a pneumatic under pressure is supplied to a common operating medium connector 39 of the adapter flange 21, this pressure is then supplied via the operating medium channel 14 at the same time to the connecting bores 18 and thus also to the suction devices 28 connected to the suction adapters 27. When the gripping device 1 is lowered onto an article 2, the suction cups 31 will contact the surface of the article 2, will adhere fixedly thereto, and thus secure the article 2. As a result of the elasticity of the suction device 28, the fold (bellows structure) 38 will contract so that the length y (Fig. 2) of the suction device 28 will shorten. In this way, the article 2 is pulled upwardly in the direction toward the flat side 4 of the base member 3 and will come to rest against the flat side 4 which thus forms not only a support surface for the gripped article 2 but also aligns the gripped article relative to the support surface. This is advantageous in particular for articles that are flaccid or slack (flexible). In the active gripping position the contact surfaces 33 of the gripping head 32 or the suction cup 31 are positioned approximately in the plane of the flat side 4.

The distance x of the suction cup 28 in the rest position between the contact surfaces 33 of the suction cup 31 and the flat side 4 is reduced in the active gripping positioned to approximately zero so that the gripped article 2 is not only secured or held in position by the suction device 28 but at the same time rests against the flat side 4 of the base member 3 forming a support surface.

The flat side 4 thus provides an abutment for the gripped article 2 so that even for great acceleration forces acting on the gripping device in all spatial directions a detachment of the article 2 from the gripping device is prevented. In particular in the case of flexible or flaccid articles such as raw sausages or the like, the additional contact of the gripped article 2 on the flat side 4 of the base member 3 provides a stiffening or reinforcement which substantially reduces or eliminates swinging of a flexible article 2. Even for great accelerations and great movements of the article gripping device across a curvy movements path, a safe holding action of the flexible article is ensured. In order to achieve a good holding action also parallel to the support surface, the surface is designed as a friction surface which can be machined so as to increase the coefficient of friction. The frictional forces acting on the articles prevent sliding of the articles resting against the support surface.

While specific embodiments of the invention have been shown and described in detail to illustrate the inventive principles, it will be understood that the invention may be embodied otherwise without departing from such principles.

Claims

1.An article gripping device for automation technology, the gripping device comprising:
a base member (3) having a flat side (4);
at least one gripping element (20) having a gripping head (32) arranged on the flat side (4) of the base member (3);
wherein the gripping head (32) has a contact surface (33) resting against the article being gripped, wherein the gripping head (32) has an active gripping position in which an article is gripped and an initial position in which no article is gripped, wherein the contact surface (33) in the active gripping position is retracted relative to a first position of the contact surface (33) in the initial position of the gripping head (22);
wherein in the active gripping position the gripping element (20) is sunk into the flat side (4) of the base member (3) and the contact surface (33) of the gripping head (32) is positioned approximately in the plane of the flat side (4); and
wherein the flat side (4) of the base member (3) forms a support surface for the article being gripped.

2. The gripping device according to claim 1, wherein the base member (3) has a receiving bore (17) for the at least one gripping element (20), wherein the gripping head (32) is positioned with minimal radial play in the receiving bore (17), wherein the receiving bore (17) has an inner circumferential surface (35) forming a lateral support for the gripping head (32).

3.The gripping device according to claim 1, wherein the base member (3) has a parallelepipedal shape and has inner recesses (8, 9).

4. The gripping device according to claim 3, wherein the inner recesses (8, 9) are open toward the flat side (4) and toward at least one lateral narrow side of the base member (3).

5. The gripping device according to claim 3, wherein the base member (3) has at least one mounting opening (16) arranged in the flat side (4) for the at least one gripping element (20) and wherein the inner recesses (8, 9) are greater than the at least one mounting opening (16) provided in the flat side (4).

6. The gripping device according to claim 1, wherein in the flat side (4) of the base member (3) two or more of said at least one gripping element (20) are arranged.

7. The gripping device according to claim 6, wherein the two or more gripping elements (20) are positioned at a spacing to one another.

8.The gripping device according to claim 7, wherein the two or more gripping elements (20) are arranged at distal ends (4a, 4b) of the flat side (4).

9. The gripping device according to claim 1, wherein the at least one gripping element (20) is an elastic suction device (28) having a suction cup (31) forming the gripping head (32).

10. The gripping device according to claim 8, wherein the suction device (28) is a pneumatic suction device.

11. The gripping device according to claim 1, comprising a common operating medium connector (39), wherein the at least one gripping element (20) is connected to the common operating medium connector (39).

12.The gripping device according to claim 1, wherein the base member (3) is comprised of plastic material.
12.
